(19) United States
(12) Patent Application Publication
(10) Pub. No.: US 2026/0176411 A1
(43) Pub. Date: Jun. 25, 2026

(54) ADHESIVE COMPOSITION, MULTILAYER BODY AND PACKAGING MATERIAL

(71) Applicant: DIC Corporation, Tokyo (JP)

(72) Inventors: Katsuhiko Okada, Tokyo (JP); Ryouji Kimura, Tokyo (JP); Miho Takeda, Tokyo (JP); Toshio Watanabe, Tokyo (JP); Keisuke Wakahara, Tokyo (JP); Shinya Yamamoto, Takaishi-shi (JP); Kouhei Okino, Takaishi-shi (JP)

(73) Assignee: DIC Corporation, Tokyo (JP)

(21) Appl. No.: 19/128,696

(22) PCT Filed: Nov. 30, 2023
(86) PCT No.: PCT/JP2023/042853

§ 371 Date: May 9, 2025

(30) Foreign Application Priority Data
Dec. 15, 2022 (JP) 2022-200089

(51) Int. Cl. C08G 18/75; B32B 7/12; B32B 27/32; C08G 18/10; C08G 18/12; C08G 18/36

(52) U.S. Cl. CPC C08G 18/755; B32B 7/12; B32B 27/32; C08G 18/10; C08G 18/12; C08G 18/36

(57) ABSTRACT

Disclosed are an adhesive composition including an oil and/or fat (A) containing an acid anhydride group and a curing agent (H), in which the curing agent (H) contains an acid-modified polyol (B) and an amine compound (C), a laminate including a first substrate, an adhesive agent layer, and a second substrate stacked in this order, in which the adhesive agent layer is the adhesive composition; and a packaging material. Preferably, the oil and/or fat (A) containing an acid anhydride group is a maleic anhydride-modified vegetable oil (A1), the acid-modified polyol (B) is an acid-modified polyester polyol, and the amine compound (C) contains a tertiary amine-containing polyol.

### TECHNICAL FIELD

The present invention relates to a two-part curable adhesive composition, a laminate obtained by laminating various substrates using the adhesive, and a packaging material.

### BACKGROUND ART

Laminated films (also referred to as laminate films in some cases) used for various packaging materials, labels, and the like are imparted with designs, functionality, preservation, convenience, and transportability by lamination of various plastic films, metal foils, and the like, and in particular, a packaging material obtained by molding the laminated film into a bag shape is used as a packaging material for foods, pharmaceuticals, detergents, and the like. As an adhesive used for laminating these films, a reactive adhesive (also referred to as a two-part adhesive) obtained by combining a polyisocyanate composition and a polyol composition is known.

Although a reactive adhesive obtained by combining a polyisocyanate composition and a polyol composition has many advantages such as not only adhesive strength but also moderate curing speed and abundant raw material source, on the other hand, there are problems such as difficulty in handling (skin sensitization, inhalation toxicity) derived from high reactivity of isocyanate and generation of a primary aromatic amine which is a carcinogen during a curing reaction, and a reactive adhesive having higher safety is desired in the market.

In addition, in recent years, there has been a strong demand for a laminated film suitable for recovery and sorting reuse of plastic waste due to the obligation to recycle plastic container packaging. It is generally recognized that a reactive adhesive obtained by combining a polyisocyanate composition and a polyol composition is a thermosetting resin which is difficult to thermally decompose and is difficult to recycle. In addition, most of the laminated films distributed are provided with display of product names and the like and decorativeness by printing inks and the like, and there is also a problem that these printing inks cannot be completely separated in a recycling process, and recycled and recovered products are colored or printing patterns remain.

On the other hand, biomass of biologically derived resources has attracted attention. In particular, since plants grow by absorbing carbon dioxide in the atmosphere by photosynthesis using sunlight as energy, it is considered that in a product (biomass plastic, synthetic fiber, etc.) obtained by commercializing a plant-derived raw material, an absorption amount of carbon dioxide by photosynthesis in a growth process of plants and an emission amount of carbon dioxide by incineration of plants are offset, and the product does not affect an increase or decrease of carbon dioxide in the atmosphere (carbon neutral), and development thereof is expected. However, reported biodegradable resins often have high viscosity, and use of an organic solvent is essential in use, so that an influence of the organic solvent discharged after use on the environment cannot be ignored. As described above, both biodegradability and adhesiveness that satisfy the requirements from the market cannot be achieved at the present time. For these reasons, an adhesive having both recyclability and biodegradability has not yet been distributed.

As an adhesive having high safety and adhesive strength comparable to a known reactive adhesive obtained by combining a polyisocyanate composition and a polyol composition, the present applicants have previously developed an adhesive composition characterized by containing a maleic anhydride-modified vegetable oil (A1) and a curing agent (B) containing a polyol (BO) and an amine compound (C) (see, for example, Patent Document 1). However, this adhesive has not been given functionality from the viewpoint of recyclability and biodegradability.

### CITATION LIST

### Patent Document

Patent Document 1: JP 2022-518878 W

### SUMMARY OF INVENTION

### Technical Problem

The problem to be solved by the present invention is to provide a reactive adhesive composition which has high safety, has adhesive strength comparable to a known reactive adhesive obtained by combining a polyisocyanate composition and a polyol composition, and is excellent in recyclability and biodegradability of a laminated film.

### Solution to Problem

That is, the present invention provides an adhesive composition including an oil and/or fat (A) containing an acid anhydride group and a curing agent (H), wherein the curing agent (H) contains an acid-modified polyol (B) and an amine compound (C).

The present invention also provides a laminate including a first substrate, an adhesive agent layer, and a second substrate stacked in this order, wherein the adhesive agent layer is the adhesive composition.

The present invention also provides a packaging material obtained by molding the laminate into a bag shape.

### Advantageous Effects of Invention

The adhesive composition of the present invention has high safety, has adhesive strength comparable to a known reactive adhesive obtained by combining a polyisocyanate composition and a polyol composition, and forms a laminated film which is not only excellent in recyclability of the laminated film but also excellent in biodegradability. Since the adhesive composition has high safety and excellent recyclability and biodegradability, the adhesive composition can be suitably used particularly as a food packaging bag.

### DESCRIPTION OF EMBODIMENTS

(Oil and/or Fat (A) Containing Acid Anhydride Group)

The oil and/or fat (A) used in the present invention contains an acid anhydride group.

Fats and/or oils are substances having structure of esters of fatty acids and glycerin, that is, triglycerides, and are widely present in natural organisms. As the oil and/or fat (A) containing an acid anhydride group used in the present invention, the oil and/or fat (A) containing an acid anhydride group obtained by introducing (adding) an acid anhydride group to oil and/or fat containing a double bond derived from an unsaturated fatty acid in a chemical structure is suitably used.

Examples of the oil and/or fat containing a double bond derived from an unsaturated fatty acid in the chemical structure preferably include a drying oil (iodine value>130) and/or a semi-drying oil (iodine value from 100 to 130), and examples of the vegetable oil include tung oil, linseed oil, perilla oil, safflower oil, dehydrated castor oil, safflower oil, soybean oil, rapeseed oil, sunflower oil, sesame oil, rice oil, cottonseed oil, corn oil, tall oil, poppy oil, walnut oil, and pine seed oil. Examples of the animal oil include fish oil (sardine oil, pacific saury oil, herring oil, etc.).

In the present invention, a regenerated vegetable oil recovered/regenerated after being provided for food such as a tempura oil can also be used.

Among these oils and/or fats, tung oil, soybean oil, rapeseed oil, and linseed oil can be suitably used because of their easy availability.

As an acid anhydride group-containing compound used for introducing an acid anhydride group into the oil and/or fat, a compound having a double bond in the molecule can be used, and examples thereof include maleic anhydride, citraconic anhydride, and tetrahydrophthalic anhydride, among which maleic anhydride can be suitably used in view of ease of introduction and reactivity of the acid anhydride group.

A description will be given taking maleic anhydride as an example of the acid anhydride group-containing compound.

An amount of maleic anhydride introduced is preferably from 19 to 34 g (from 0.19 to 0.35 mol), more preferably from 22 to 29 g (from 0.22 to 0.30 mol) with respect to 100 g of the oil and/or fat from the viewpoint of the adhesive strength of an adhesive cured product obtained by reacting with the curing agent (H) described later. When the amount of maleic anhydride introduced is too large, the viscosity becomes remarkably high, and handling may be difficult.

As a method for adding maleic anhydride to oil and/or fat, a known and commonly used method can be applied. For example, when a drying oil is used as the oil and/or fat, a method of performing a Diels-Alder reaction with maleic anhydride at from 50 to 150° C., more preferably at from 60 to 120° C. can be applied. When a semi-drying oil is used as the oil and/or fat, maleic anhydride can be introduced into the oil and/or fat by a method of performing an Alder-Ene reaction at from 150 to 250° C., more preferably from 180 to 220° C. In addition, a method can also be used in which maleic anhydride is reacted using a semi-drying oil until a certain reaction rate is reached, and then a drying oil is added to react the remaining maleic anhydride.

In the reaction, a small amount of organic peroxide may be added, or a known and commonly used polymerization inhibitor may be added. Examples of the polymerization inhibitor include benzoquinone, hydroquinone, hydroquinone monomethyl, tert-butyl hydroquinone, dibutylhydroxytoluene, and 4-tertiary-butylcatechol. A method of blowing air can also be used.

### (Curing Agent (H))

In the present invention, by using the acid-modified polyol (B) as an essential component of the curing agent (H), alkali solubility can be imparted while maintaining adhesiveness.

### (Acid-Modified Polyol (B))

In the present invention, by using the acid-modified polyol (B) as the curing agent, alkali solubility can be imparted while maintaining the adhesiveness. In addition, excellent biodegradability is exhibited.

The acid-modified polyol (B) used in the present invention is a polyol having an acidic group in the polyol molecule, and examples of the acidic group include a carboxyl group and a phosphate group, and among them, a carboxyl group is preferable from the viewpoint of ease of production.

A method for producing the acid-modified polyol (B) is not particularly limited, and a method in which an acid anhydride group-containing compound is added to hydroxyl groups of various polyols to introduce a carboxyl group is preferably used. Examples of the acid anhydride group-containing compound to be added to various polyols include trimellitic anhydride, phthalic anhydride, hexahydrophthalic anhydride, succinic anhydride, maleic anhydride, and pyromellitic anhydride, and among them, trimellitic anhydride is preferably used.
The polyester polyol can also be produced by adjusting the composition so as to have both a hydroxyl group and a carboxyl group.

Examples of the various polyols include polymer polyols selected from polyester polyols, polyether polyols, polyurethane polyols, polyether ester polyols, polyester (polyurethane) polyols, polyether (polyurethane) polyols, acrylic polyols, polycarbonate polyols, polyhydroxyl alkanes, castor oils, and mixtures thereof. Among them, polyester polyol is preferably used.

Examples of the polyester polyol include a polyester polyol obtained by reacting a dibasic acid such as terephthalic acid, isophthalic acid, phthalic anhydride, adipic acid, azelaic acid, sebacic acid, or dimer acid (a liquid fatty acid containing, as a main component, a C36 dibasic acid generated by dimerization of a C18 unsaturated fatty acid containing a vegetable oil-based oil and/or fat as a raw material, and also containing a monobasic acid and a tribasic acid) or a dialkyl ester thereof or a mixture thereof with, for example, glycols such as ethylene glycol, propylene glycol, diethylene glycol, butylene glycol, neopentyl glycol, 2-methyl-1,3-propanediol, 1,6-hexanediol, 3-methyl-1,5-pentanediol, 3,3′-dimethylolheptane, polyoxyethylene glycol, polyoxypropylene glycol, and polytetramethylene ether glycol, a trihydric or tetrahydric alcohol such as glycerin (glycerol), trimethylolethane, trimethylolpropane, and pentaerythritol, or a mixture thereof, and a polyester polyol obtained by ring-opening polymerization of lactones such as polycaprolactone, polyvalerolactone, and poly(β-methyl-γ-valerolactone).

In addition, glycols (diols) such as ethylene glycol, propylene glycol, diethylene glycol, 1,4-butanediol, and 1,6-hexanediol, and trihydric or tetrahydric alcohols such as glycerin, trimethylolethane, trimethylolpropane, and pentaerythritol to which the acid anhydride group-containing compound is added can also be used. Among them, a method of adding an acid anhydride group-containing compound to the polyester polyol is preferable from the viewpoint of being able to impart excellent delaminating property and biodegradability.

The acid value of the acid-modified polyol (B) is preferably in a range of from 5 to 40 mgKOH/g, more preferably in a range of from 10 to 30 mgKOH/g. The acid value is a value measured according to JIS K0070.

A hydroxyl value of the acid-modified polyol (B) is preferably from 50 to 330 (mg-KOH/g), more preferably in a range of from 100 to 250. When the hydroxyl value is less than 50 (mg-KOH/g), the viscosity of the acid-modified polyol (B) may be high, and handling may be difficult. When the hydroxyl value is more than 330 (mg-KOH/g), sufficient adhesive strength may not be obtained.

The hydroxyl value is a value measured according to JIS K0070.

The molecular weight of the acid-modified polyol (B) is in a range of from 1500 to 8000 as a weight average molecular weight, and more preferably in a range of from 2500 to 5000. The molecular weight is a value as measured by gel permeation chromatography (GPC) under the following conditions.

Measurement apparatus: high-speed GPC apparatus (“HLC-8220GPC” available from Tosoh Corporation) Column:

The following columns available from Tosoh Corporation were connected in series and used.
“TSKgel G5000” (7.8 mm I.D.×30 cm)×1 column
“TSKgel G4000” (7.8 mm I.D.×30 cm)×1 column
“TSKgel G3000” (7.8 mm I.D.×30 cm)×1 column
“TSKgel G2000” (7.8 mm I.D.×30 cm)×1 column
Detector: RI (differential refractometer)
Column temperature: 40° C.
Eluent: tetrahydrofuran (THF)
Flow rate: 1.0 mL/min
Injection volume: 100 μL (tetrahydrofuran solution with a sample concentration of 0.4 mass %)
Standard sample: A calibration curve is created using the following standard polystyrenes.

### [Standard Polystyrene]

“TSKgel Standard Polystyrene A-500” available from Tosoh Corporation
“TSKgel Standard Polystyrene A-1000” available from Tosoh Corporation
“TSKgel Standard Polystyrene A-2500” available from Tosoh Corporation
“TSKgel Standard Polystyrene A-5000” available from Tosoh Corporation
“TSKgel Standard Polystyrene F-1” available from Tosoh Corporation
“TSKgel Standard Polystyrene F-2” available from Tosoh Corporation
“TSKgel Standard Polystyrene F-4” available from Tosoh Corporation
“TSKgel Standard Polystyrene F-10” available from Tosoh Corporation
“TSKgel Standard Polystyrene F-20” available from Tosoh Corporation
“TSKgel Standard Polystyrene F-40” available from Tosoh Corporation
“TSKgel Standard Polystyrene F-80” available from Tosoh Corporation
“TSKgel Standard Polystyrene F-128” available from Tosoh Corporation
“TSKgel Standard Polystyrene F-288” available from Tosoh Corporation
“TSKgel Standard Polystyrene F-550” available from Tosoh Corporation

### (Amine Compound (C))

In the present invention, the curing agent preferably contains at least one amine compound (C) in addition to the acid-modified polyol (B). The amine compound (C) not only contributes to the formation of an adhesive cured product as a curing agent, but also can improve the curing rate because nitrogen contained in the structure acts as a catalyst for accelerating the reaction between an acid anhydride group and a hydroxyl group. As the amine compound (C), one type of amine compound may be used, or a plurality of types of amine compounds may be used in combination.

The amine compound (C) is preferably a compound containing two or more primary and/or secondary amino groups in one molecule or a compound containing one or more tertiary amino groups in one molecule, and examples thereof include a tertiary amine-containing polyol (B2) having a plurality of hydroxyl groups, an amidopolyol, and a polyamine. In particular, the tertiary amine-containing polyol (B2) can be preferably used because a balance between the reactivity with the oil and/or fat (A) containing an acid anhydride group and physical properties of a film to be formed can be easily adjusted. In addition, an amino alcohol having both a primary or secondary amino group and a hydroxyl group in one molecule can also be used. Examples of the amino alcohol include monomethanolamine, N-methylmethanolamine, N-ethylmethanolamine, dimethanolamine, monoethanolamine, N-methylethanolamine, N-ethylethanolamine, and diethanolamine.

As the tertiary amine-containing polyol (B2), a tertiary amine compound having a plurality of hydroxyl groups is preferable, and from 2 to 6 hydroxyl groups are particularly preferable. In addition, one or more tertiary amino groups may be contained, and preferably one or two tertiary amino groups are contained.

Specific examples thereof include polypropylene glycol ethylenediamine ether, tri (1,2-polypropylene glycol)amine, N-ethyldiethanolamine, N-methyl-N-hydroxyethyl-N-hydroxyethoxyethylamine, pentakis (hydroxypropyl) diethylenetriamine, and tetrakishydroxypropylethylenediamine.

As the tertiary amine-containing polyol (B2), a commercially available product may be used. Examples of commercially available products include TE-360 (tertiary amine-containing trifunctional polyol available from KUKDO Chemical (Kunshan) Co., Ltd. (China)), TD-401 (tertiary amine-containing tetrafunctional polyol available from KUKDO Chemical (Kunshan) Co., Ltd. (China)), EDP-300, and EDP-450 (tertiary amine-containing tetrafunctional polyols all available from ADEKA Corporation).

Examples of the amide polyol include polyester amide polyols, and examples thereof include polyester amide polyols obtained by using aliphatic diamines having an amino group such as ethylenediamine, propylenediamine, and hexamethylenediamine together as raw materials in the esterification reaction of the polyester polyol.

The polyamine is not particularly limited, and a known polyamine having a primary and/or secondary amino group can be used. The polyamine may contain a tertiary amine.

Examples of the aliphatic diamines (from 2 to 18 carbon atoms) include ethylenediamine, propylenediamine, trimethylenediamine, tetramethylenediamine, and hexamethylenediamine, and the like, which are alkylene (from 2 to 6 carbon atoms) diamines, aliphatic diamines such as polyalkylene (from 2 to 6 carbon atoms), diethylenetriamine which is diamine, iminobispropylamine, bis(hexamethylene)triamine, triethylenetetramine, tetraethylenepentamine, and pentaethylenehexamine,
dialkyl (from 1 to 3 carbon atoms) aminopropylamine, trimethylhexamethylenediamine, aminoethylethanolamine, 2,5-dimethyl-2,5-hexamethylenediamine, and methyliminobispropylamine, which are alkyl (from 1 to 4 carbon atoms) or hydroxyalkyl (from 2 to 4 carbon atoms) substitutes of aliphatic diamine,
1,3-diaminocyclohexane, isophoronediamine, mensendiamine, 4,4′-methylenedicyclohexanediamine (hydrogenated methylenedianiline), and the like, which are alicyclic diamines (from 4 to 15 carbon atoms) as alicyclic or heterocyclic aliphatic diamines, piperazine, N-aminoethylpiperazine, 1,4-diaminoethylpiperazine, 3,9-bis(3-aminopropyl)-2,4,8,10-tetraoxaspiro[5,5] undecane, and the like, which are heterocyclic diamines (from 4 to 15 carbon atoms), and
xylylenediamine, tetrachloro-p-xylylenediamine, and the like, which are aromatic ring-containing aliphatic amines (from 8 to 15 carbon atoms).

Examples of the aromatic diamines (from 6 to 20 carbon atoms) include unsubstituted aromatic diamines such as 1,2-, 1,3-, or 1,4-phenylenediamine, 2,4′- and 4,4′-diphenylmethanediamine, crude diphenylmethanediamine (polyphenylpolymethylenepolyamine), diaminodiphenylsulfone, benzidine, thiodianiline, 2,6-diaminopyridine, m-aminobenzylamine, triphenylmethane-4,4′,4″-triamine, and naphthylenediamine,
2,4- or 2,6-tolylenediamine, crude tolylenediamine, diethyltolylenediamine, 4,4′-diamino-3,3′-dimethyldiphenylmethane, 4,4′-bis(o-toluidine), dianisidine, diaminoditolyl sulfone, 1,3-dimethyl-2,4-diaminobenzene, 2,3-dimethyl-1,4-diaminonaphthalene, 4,4-diamino-3,3′-dimethyldiphenylmethane, and the like, which are aromatic diamines having a nuclear-substituted alkyl group (an alkyl group having from 1 to 4 carbon atoms, such as a methyl group, an ethyl group, a propyl group, and a butyl group) and mixtures of isomers thereof in various proportions,
methylenebis-o-chloroaniline, 4-chloro-o-phenylenediamine, 2-chloro-1,4-phenylenediamine, 3-amino-4-chloroaniline, 4-bromo-1,3-phenylenediamine, 2,5-dichloro-1,4-phenylenediamine, 5-nitro-1,3-phenylenediamine, 3-dimethoxy-4-aminoaniline, and the like, which are aromatic diamines having a nuclear-substituted electron withdrawing group (such as halogen atoms such as fluorine, chlorine, bromine, and iodine; alkoxy groups such as methoxy groups and ethoxy groups; nitro groups),
4,4-di(methylamino)diphenylmethane, 1-methyl-2-methylamino-4-aminobenzene, and the like, which are aromatic diamines having a secondary amino group (the above aromatic diamine in which part or all of —NH2 are substituted with —NH—R′ (R′ represents an alkyl group; for example, lower alkyl groups such as a methyl group and an ethyl group)),
a low molecular weight polyamide polyamine obtained by condensation of a polyamide polyamine (dicarboxylic acid (such as dimer acid) with an excess (2 moles or more per mole of acid) of polyamines (the above alkylene diamine, polyalkylene polyamine, and the like), and
hydrides of cyanoethylation products of polyether polyols (such as polyalkylene glycols) which are polyether polyamines.

Among the above polyamines, polyamidoamine and polyether polyamine are preferably used because a coating film excellent in strength can be formed.

As the polyamine, a commercially available product can also be used. Examples of the commercially available products include Jeffamine T-403, Jeffamine D-230, and Jeffamine D-400 (polyether polyamines all available from Huntsman International LLC. (USA)).

In the case of a polyether polyamine, the polyether polyamine is preferably bifunctional or trifunctional, and a polyether polyamine having a molecular weight of from 200 to 5000, more preferably from 200 to 1500 is preferably used.

(Polyol (B3) which is not Acid-Modified)

In the present invention, it is also preferable to use a polyol (B3) which is not acid-modified in combination as the curing agent.

As the polyol (B3) which is not acid-modified, for example, a compound having two or more hydroxyl groups on average in the molecule can be suitably used, and examples thereof include polymer polyols selected from polyester polyols, polyether polyols, polyurethane polyols, polyether ester polyols, polyester (polyurethane) polyols, polyether (polyurethane) polyols, acrylic polyols, polycarbonate polyols, polyhydroxyl alkanes, castor oils, and mixtures thereof. Among them, polyester polyol is preferably used.

Examples of the polyester polyol include a polyester polyol obtained by reacting a dibasic acid such as terephthalic acid, isophthalic acid, phthalic anhydride, adipic acid, azelaic acid, sebacic acid, or dimer acid (a liquid fatty acid containing, as a main component, a C36 dibasic acid generated by dimerization of a C18 unsaturated fatty acid containing a vegetable oil-based oil and/or fat as a raw material, and also containing a monobasic acid and a tribasic acid) or a dialkyl ester thereof or a mixture thereof with, for example, glycols such as ethylene glycol, propylene glycol, diethylene glycol, butylene glycol, neopentyl glycol, 2-methyl-1,3-propanediol, 1,6-hexanediol, 3-methyl-1,5-pentanediol, 3,3′-dimethylolheptane, polyoxyethylene glycol, polyoxypropylene glycol, and polytetramethylene ether glycol, a trihydric or tetrahydric alcohol such as glycerin (glycerol), trimethylolethane, trimethylolpropane, and pentaerythritol, or a mixture thereof, and a polyester polyol obtained by ring-opening polymerization of lactones such as polycaprolactone, polyvalerolactone, and poly(β-methyl-γ-valerolactone).

Examples of the polyether polyol include polyether polyols obtained by polymerizing an oxirane compound such as ethylene oxide, propylene oxide, butylene oxide, or tetrahydrofuran with a low molecular weight polyol, such as water, ethylene glycol, propylene glycol, trimethylolpropane, or glycerin, as an initiator. Examples of the polyether ester polyol include a polyether ester polyol obtained by reacting a dibasic acid such as terephthalic acid, isophthalic acid, phthalic anhydride, adipic acid, azelaic acid, sebacic acid, or dimer acid, a dialkyl ester thereof, or a mixture thereof with the above polyether polyol.

The polyurethane polyol is a polyol having a urethane bond in one molecule, and examples thereof include a reaction product of a polyether polyol having a number average molecular weight of from 200 to 20,000 and an organic polyisocyanate, in which NCO/OH is preferably less than 1, and more preferably 0.9 or less. As the organic polyisocyanate, a polyisocyanate compound described later, particularly a diisocyanate compound can be used.

The polyether (polyurethane) polyol and the polyester (polyurethane) polyol are reaction products of a polyester polyol, a polyether ester polyol or the like and an organic polyisocyanate, and NCO/OH is preferably less than 1, and more preferably 0.9 or less.

Examples of the polycarbonate polyol include those obtained by reacting one or two or more glycols selected from ethylene glycol, propylene glycol, 1,4-butanediol, 1,5-pentanediol, 1,6-hexanediol, 3-methyl-1,5-pentanediol, 1,9-nonanediol, 1,8-nonanediol, neopentyl glycol, diethylene glycol, dipropylene glycol, 1,4-cyclohexanediol, 1,4-cyclohexanedimethanol, bisphenol A, and hydrogenated bisphenol A with dimethyl carbonate, diphenyl carbonate, ethylene carbonate, phosgene, and the like.

Examples of the acrylic polyol include those obtained by copolymerization of hydroxyethyl acrylate, hydroxypropyl acrylate, and hydroxybutyl acrylate containing one or more hydroxyl groups in one molecule, or its corresponding methacrylic acid derivative, with, for example, acrylic acid, methacrylic acid or an ester thereof.

Examples of the polyhydroxyalkanes include butadiene and liquid rubbers obtained by copolymerization of butadiene and acrylamide.

In the case of a polyester polyol, a polyester polyol having a number average molecular weight of from 400 to 2000 and a hydroxyl value of from 60 to 300 can be preferably used.

In addition, glycols (diols) such as ethylene glycol, propylene glycol, diethylene glycol, 1,4-butanediol, and 1,6-hexanediol, and trihydric or tetrahydric alcohols such as glycerin, trimethylolpropane, and pentaerythritol can be directly used as a part of the curing agent (H).

The polyol (B3) which is not acid-modified may be used alone or in combination of a plurality thereof.

### (Acid Value of Curing Agent (H))

The acid value of the curing agent (H) is preferably in a range of from 5 to 30 mgKOH/g, more preferably in a range of from 10 to 20 mgKOH/g as a whole of the curing agent (H) containing the acid-modified polyol (B), the amine compound (C), and other compounds as necessary.

As long as the acid value of the curing agent (H) is within the above range, the acid-modified polyol (B) and the polyol (B3) which is not acid-modified may be mixed and used.

A blending ratio of the oil and/or fat (A) containing an acid anhydride group and the curing agent (H) is preferably in a range of from 0.5 to 1.5, more preferably from 0.8 to 1.25 in terms of a molar ratio of the acid anhydride group of the oil and/or fat (A) containing the acid anhydride group and the functional group capable of reacting with the acid anhydride group of the curing agent (H) (acid anhydride group/functional group capable of reacting with acid anhydride group). When the blending ratio of the oil and/or fat (A) containing an acid anhydride group and the curing agent (H) is within the above range, a coating film excellent in adhesive strength can be obtained.

When the curing agent (H) contains the amine compound (C), an amount of the amine compound (C) used is preferably in a range of from 0.05 to 0.7, more preferably from 0.1 to 0.5 in terms of a molar ratio of nitrogen of the amine compound (C) to the acid anhydride group of the oil and/or fat (A) containing an acid anhydride group (nitrogen/acid anhydride group). When the use amount of the amine compound (C) is within the above range, an adhesive cured product excellent in adhesive strength can be obtained while securing a suitable pot life.

Examples of specific preferable combinations of the oil and/or fat (A) containing an acid anhydride group and the curing agent (H) include
1) a combination of maleic anhydride-modified tung oil as the oil and/or fat (A) and an acid-modified polyester polyol (B) and a tertiary amine-containing polyol (B2) as the curing agent (H),
2) a combination of maleic anhydride-modified soybean oil as the oil and/or fat (A), the acid-modified polyester polyol (B) as the curing agent (H), and a non-acid-modified polyol (B3) and the tertiary amine-containing polyol (B2), and
3) combinations in which a plurality of vegetable oils such as soybean oil and tung oil are used in combination with vegetable oil of the oil and/or fat (A) in 1) and 2).

### (Catalyst)

A catalyst may be added to the adhesive composition of the present invention. As such a catalyst, for example, a tertiary amine compound, an aliphatic cyclic amide compound, an organometallic catalyst, or the like can be used.

Examples of the tertiary amine compound include diazabicycloundecene, diazabicyclononene, triethylenediamine, 2-methyltriethylenediamine, quinuclidine, and 2-methylquinuclidine.

Examples of the aliphatic cyclic amide compound include δ-valerolactam, ε-caprolactam, ω-enanthollactam, η-capryllactam, and β-propiolactam.

Examples of the organometallic catalyst include dibutyltin oxide, dibutyltin diacetate, dibutyltin dilaurate, dioctyltin dilaurate, bismuth octylate, bismuth neodecanoate, zirconium octylate, and zirconium neodecanoate.

Among them, the tertiary amine compound can be preferably used because it has excellent catalytic activity.

### (Solvent)

The adhesive composition of the present invention can be used as a solvent type or solventless type adhesive. The term “solvent” of the solventless type adhesive in the present invention refers to an organic solvent having high solubility capable of dissolving the polyisocyanate compound and the polyol compound used in the present invention, and the term “solventless” refers to not containing these organic solvents having high solubility. Specific examples of the organic solvent having high solubility include toluene, xylene, methylene chloride, tetrahydrofuran, methanol, ethanol, isopropyl alcohol, methyl acetate, ethyl acetate, n-butyl acetate, acetone, methyl ethyl ketone (MEK), cyclohexanone, toluol, xylol, n-hexane, and cyclohexane. Among them, toluene, xylene, methylene chloride, tetrahydrofuran, methyl acetate, and ethyl acetate are known as organic solvents having particularly high solubility.

On the other hand, when the adhesive according to the present invention is required to have a low viscosity and the like, the adhesive may be appropriately diluted with the organic solvent having high solubility according to a desired viscosity and used. In this case, either one of the oil and/or fat (A) having an acid anhydride group and the curing agent (H) may be diluted, or both of them may be diluted. Examples of the organic solvent used in such a case include methanol, ethanol, isopropyl alcohol, methyl acetate, ethyl acetate, n-butyl acetate, acetone, methyl ethyl ketone (MEK), cyclohexanone, toluol, xylol, n-hexane, and cyclohexane. Among them, ethyl acetate and methyl ethyl ketone (MEK) are preferable from the viewpoint of solubility, and ethyl acetate is particularly preferable. An amount of the organic solvent used depends on the required viscosity, and is often in a range of about from 20 to 50 mass %.

### (Other Optional Components)

In the adhesive composition of the present invention, a pigment may be used in combination as necessary. The usable pigments in this case are not particularly limited, and examples thereof include organic pigments and inorganic pigments described in “Paint Materials Handbook” 1970 edition (edited by the Japan Paint Manufacturers Association) such as extender pigments, white pigments, black pigments, gray pigments, red pigments, brown pigments, green pigments, blue pigments, metal powder pigments, luminescent pigments, and pearlescent pigments, as well as plastic pigments and the like. There are various specific examples of these colorants, examples of organic pigments include various insoluble azo pigments such as Benzidine Yellow, Hansa Yellow, and Rekiddo 4R; soluble azo pigments such as Rekiddo C, Carmine 6B, and Bordeaux 10; various (copper) phthalocyanine pigments such as phthalocyanine blue and phthalocyanine green; various chlorine-based dyeing lakes such as Rhodamine lake and methyl violet lake, various mordant dye pigments such as quinoline lake and fast sky blue; various vat dye-based pigments such as anthraquinone-based pigments, thioindigo-based pigment, and perinone-based pigments; various quinacridone pigments such as Syncasia Red B; various dioxazine pigments such as dioxazine violet; various condensed azo pigments such as chromophthal; aniline black and the like.

Examples of inorganic pigments include various chromates such as chrome yellow, zinc chromate, and molybdate orange; various ferrocyanic compounds such as Prussian blue; various metal oxides such as titanium oxide, zinc white, Mapikoero, iron oxide, bengara, chrome oxide green, and zirconium oxide; various sulfides or selenides such as cadmium yellow, cadmium red, and mercury sulfide; various sulfates such as barium sulfate and lead sulfate; various silicates such as calcium silicate and ultramarine blue; various carbonates such as calcium carbonate and magnesium carbonate; various phosphates such as cobalt violet and manganese violet; various metal powders such as aluminum powder, gold powder, silver powder, copper powder, bronze powder, and brass powder; flake pigments and mica flake pigments of these metals; metallic pigments and pearl pigments such as mica flake pigments and mica iron oxide pigment in the form coated with metal oxide; graphite, carbon black, and the like.

Examples of extender pigments include precipitated barium sulfate, Gohun pigment, precipitated calcium carbonate, calcium bicarbonate, white limestone, alumina white, silica, hydrous fine silica (white carbon), ultrafine anhydrous silica (Aerosil), silica sand, talc, precipitated magnesium carbonate, bentonite, clay, kaolin, ocher, and the like.

Furthermore, examples of plastic pigments include “Grandoll PP-1000” and “PP-2000S” available from DIC Corporation, and the like.

As the pigments used in the present invention, inorganic oxides such as titanium oxide and zinc white as the white pigment and carbon black as the black pigment are more preferable since these are excellent in durability, weather resistance, and design properties.

The mass ratio of the pigment used in the present invention is preferably from 1 to 400 parts by mass and more preferably from 10 to 300 parts by mass, with respect to 100 parts by mass of the solid content of the adhesive composition of the present invention, since the adhesiveness, the blocking resistance, and the like are excellent.

### (Adhesion Promoter)

An adhesion promoter can also be used in combination with the adhesive composition used in the present invention. Examples of the adhesion promoter include coupling agents such as a silane coupling agent, a titanate-based coupling agent, and an aluminum-based coupling agent, and epoxy resins.

Examples of the silane coupling agent include aminosilanes such as γ-aminopropyltriethoxysilane, γ-aminopropyltrimethoxysilane, N-β (aminoethyl)-γ-aminopropyltrimethoxysilane, N-β(aminoethyl)-γ-aminopropyltrimethyldimethoxysilane, and N-phenyl-γ-aminopropyltrimethoxysilane; epoxysilanes such as β-(3,4-epoxycyclohexyl)ethyltrimethoxysilane, γ-glycidoxypropyltrimethoxysilane, and γ-glycidoxypropyltriethoxysilane; vinylsilanes such as vinyltris(β-methoxyethoxy) silane, vinyltriethoxysilane, vinyltrimethoxysilane, and γ-methacryloxypropyltrimethoxysilane; hexamethyldisilazane, and γ-mercaptopropyltrimethoxysilane.

Examples of the titanate-based coupling agent tetraisopropoxytitanium, tetra-n-butoxytitanium, butyl titanate dimer, include tetrastearyltitanate, titanium acetylacetonate, titanium lactate, tetraoctylene glycol titanate, titanium lactate, and tetrastearoxytitanium.

Examples of the aluminum-based coupling agent include acetoalkoxyaluminum diisopropylate.

Examples of the epoxy resin include epoxidized oil and/or fat typified by commercially available epoxidized soybean oil, various epoxy resins such as an epi-bis type epoxy resin, a novolac type epoxy resin, a β-methyl epichloro type epoxy resin, a cyclic oxirane type epoxy resin, a glycidyl ether type epoxy resin, a glycidyl ester type epoxy resin, a polyglycol ether type epoxy resin, a glycol ether type epoxy resin, an epoxidized fatty acid ester type epoxy resin, a polyvalent carboxylic acid ester type epoxy resin, an aminoglycidyl type epoxy resin, and a resorcin type epoxy resin; and compounds such as triglycidyl tris(2-hydroxyethyl) isocyanurate, neopentyl glycol diglycidyl ether, 1,6-hexanediol diglycidyl ether, acrylic glycidyl ether, 2-ethylhexyl glycidyl ether, phenyl glycidyl ether, phenol glycidyl ether, p-t-butylphenyl glycidyl ether, adipic acid diglycidyl ester, and o-phthalic acid diglycidyl ester, glycidyl methacrylate, and butyl glycidyl ether. However, the amount is preferably kept to a minimum.

As other additives other than the above, leveling agents, inorganic fine particles such as colloidal silica and alumina sol, polymethyl methacrylate-based organic fine particles, defoaming agents, anti-sagging agents, wetting and dispersing agents, viscosity modifiers, ultraviolet absorbing agents, metal inactivating agents, peroxide decomposing agents, flame retardants, reinforcing agents, plasticizers, lubricants, rust inhibitors, fluorescent whitening agents, inorganic heat ray absorbers, flameproofing agents, antistatic agents, dehydrating agents, known and commonly used thermoplastic elastomers, tackifiers, phosphoric acid compounds, melamine resins, or reactive elastomers can be used. The content of these additives can be appropriately adjusted and used within a range in which the function of the adhesive composition used in the present invention is not impaired.

These additives can be used by being mixed with any one of the oil and/or fat (A) containing an acid anhydride group and the curing agent (H), or by being blended as a third component at the time of application.

### Laminate

The laminate of the present invention is a laminate obtained by stacking a first substrate, an adhesive agent layer, and a second substrate in this order. Specifically, the laminate is obtained by bonding the first substrate and the second substrate, which are a film, paper, and the like, to each other by a dry lamination method or a non-solvent lamination method using the adhesive according to the present invention.

### (First Substrate and Second Substrate)

The first substrate and the second substrate are not particularly limited and can be appropriately selected according to a desired application. However, when the first substrate and the second substrate are plastic films, the effect of the adhesive according to the present invention can be exhibited to the maximum. For example, a plastic film is mainly used as a substrate in packaging material for foods, pharmaceuticals, detergents, and the like, which are main applications of the present invention. These plastic films may be appropriately provided with a layer according to a desired application, such as a vapor-deposited layer of a metal such as aluminum or a metal oxide such as silica or alumina, a coating layer having functionality, a printed layer, and a primer layer for easily providing a printed layer or a vapor-deposited layer. On the other hand, a laminate in which a reactive adhesive other than the adhesive according to the present invention is used may be used; however, there is a possibility that recyclability is poor.

### (Film)

The film is not particularly limited, and a film according to the application can be appropriately selected. Examples of the film for food packaging include polyethylene terephthalate (PET) films, polystyrene films, polyamide films, polyacrylonitrile films, polyolefin films such as polyethylene films (LLDPE: low density polyethylene film, HDPE: high density polyethylene film) and polypropylene films (CPP: unstretched polypropylene film, OPP: biaxially stretched polypropylene film), polyvinyl alcohol films, and ethylene-vinyl alcohol copolymer films.

The film may be subjected to a stretching treatment. As a stretching treatment method, it is common to melt and extrude a resin by an extrusion film forming method or the like to form a sheet and then to perform simultaneous biaxial stretching or sequential biaxial stretching. In the case of sequential biaxial stretching, commonly, longitudinal stretching treatment is first performed and then transverse stretching is performed. Specifically, a method of combining longitudinal stretching utilizing a speed difference between rolls and transverse stretching using a tenter is often used.

As described above, a film in which a vapor-deposited layer of a metal such as aluminum or a metal oxide such as silica or alumina is stacked, or a barrier film containing a gas barrier layer such as polyvinyl alcohol, an ethylene-vinyl alcohol copolymer, or vinylidene chloride may be used in combination. By using such a film, a laminate having barrier properties against water vapor, oxygen, an alcohol, an inert gas, a volatile organic substance (smell), and the like can be produced.

The film surface may be subjected to various surface treatments such as a flame treatment and a corona discharge treatment so as to form an adhesive layer free from defects such as film breakage and repelling, as necessary.

Alternatively, the laminate of the present invention can be obtained by applying the adhesive according to the present invention as an adhesion auxiliary agent (anchor coating agent) to a film with a laminator, performing a curing reaction, and then laminating a melted polymer material with an extruder (extrusion lamination method). As the film, the same film as that used in the dry lamination method and the non-solvent lamination method described above can be used. The polymer material to be molten is preferably a polyolefin-based resin such as a low-density polyethylene resin, a linear low-density polyethylene resin, or an ethylene-vinyl acetate copolymer resin.

More specific examples of the laminate configuration include, but are not limited to:
(1) substrate film 1/adhesive layer 1/sealant film;
(2) substrate film 1/adhesive layer 1/metal-deposited unstretched film;
(3) substrate film 1/adhesive layer 1/metal-deposited stretched film;
(4) transparent vapor-deposited stretched film/adhesive layer 1/sealant film;
(5) substrate film 1/adhesive layer 1/substrate film 2/adhesive layer 2/sealant film;
(6) substrate film 1/adhesive layer 1/metal-deposited stretched film/adhesive layer 2/sealant film;
(7) substrate film 1/adhesive layer 1/transparent vapor-deposited stretched film/adhesive layer 2/sealant film;
(8) substrate film 1/adhesive layer 1/metal layer/adhesive layer 2/sealant film;
(9) substrate film 1/adhesive layer 1/substrate film 2/adhesive layer 2/metal layer/adhesive layer 3/sealant film; and
(10) substrate film 1/adhesive layer 1/metal layer/adhesive layer 2/substrate film 2/adhesive layer 3/sealant film.

Examples of the substrate film 1 used in the configuration (1) include an OPP film, a PET film, and a nylon film. As the substrate film 1, a substrate film subjected to coating for the purpose of improving gas barrier properties, ink receptivity when a printed layer described later is provided, or the like may be used. Examples of commercially available products of the substrate film 1 subjected to coating include a K-OPP film and a K-PET film. The adhesive layer 1 is a cured coating film of the adhesive according to the present invention. Examples of the sealant film include a CPP film and an LLDPE film. A printed layer to be described later may be provided on a surface of the substrate film 1 on the adhesive layer 1 side (when the substrate film 1 to which coating has been applied is used, the surface of the coating layer on the adhesive layer 1 side). The printed layer is formed by a general printing method used in the known art for printing on a polymer film using various printing inks such as gravure ink, flexographic ink, offset ink, stencil ink and inkjet ink.

Examples of the substrate film 1 used in the configurations (2) and (3) include an OPP film and a PET film. The adhesive layer 1 is a cured coating film of the adhesive according to the present invention. A VM-CPP film produced by vapor deposition of a metal such as aluminum on a CPP film can be used as the metal-deposited unstretched film, and a VM-OPP film produced by vapor deposition of a metal such as aluminum on an OPP film can be used as the metal-deposited stretched film. In the same manner as in the configuration (1), a printed layer described later may be provided on the surface of the substrate film 1 on the adhesive layer 1 side.

Examples of the transparent vapor-deposited stretched film used in the constitution (4) include films produced by subjecting an OPP film, a PET film, a nylon film or the like to silica or alumina vapor deposition. For example, for the purpose of protecting an inorganic vapor-deposited layer of silica or alumina, a film in which coating is applied onto the vapor-deposited layer may be used. The adhesive layer 1 is a cured coating film of the adhesive according to the present invention. Examples of the sealant film include the same as that in the configuration (1). A printed layer described later may be provided on a surface of the transparent vapor-deposited stretched film on the adhesive layer 1 side (when a layer to which coating has been applied onto the inorganic vapor-deposited layer is used, the surface of the coating layer on the adhesive layer 1 side). The method for forming the printed layer is similar to that of the configuration (1).

Examples of the substrate film 1 used in the configuration (5) include a PET film. Examples of the substrate film 2 include a nylon film. At least one of the adhesive layer 1 and the adhesive layer 2 is a cured coating film of the adhesive according to the present invention. Examples of the sealant film include the same as that in the configuration (1). In the same manner as in the configuration (1), a printed layer described later may be provided on the surface of the substrate film 1 on the adhesive layer 1 side.

Examples of the substrate film 1 in the configuration (6) include the same films as those in the configurations (2) and (3). Examples of the metal-deposited stretched film include a VM-OPP film and a VM-PET film produced by vapor deposition of a metal such as aluminum on an OPP film and a PET film. At least one of the adhesive layer 1 and the adhesive layer 2 is a cured coating film of the adhesive according to the present invention. Examples of the sealant film include the same as that in the configuration (1). In the same manner as in the configuration (1), a printed layer described later may be provided on the surface of the substrate film 1 on the adhesive layer 1 side.

Examples of the substrate film 1 in the configuration (7) include a PET film. Examples of the transparent vapor-deposited stretched film include the same as that in the configuration (4). At least one of the adhesive layers 1 and 2 is a cured coating film of the adhesive according to the present invention. Examples of the sealant film include the same as that in the configuration (1). In the same manner as in the configuration (1), a printed layer described later may be provided on the surface of the substrate film 1 on the adhesive layer 1 side.

Examples of the substrate film 1 in the configuration (8) include a PET film. Examples of the metal layer include an aluminum foil. At least one of the adhesive layers 1 and 2 is a cured coating film of the adhesive according to the present invention. Examples of the sealant film include the same as that in the configuration (1). In the same manner as in the configuration (1), a printed layer described later may be provided on the surface of the substrate film 1 on the adhesive layer 1 side.

Examples of the substrate film 1 in the configurations (9) and (10) include a PET film. Examples of the substrate film 2 include a nylon film. Examples of the metal layer include an aluminum foil. At least one of the adhesive layers 1, 2, and 3 is a cured coating film of the adhesive according to the present invention. Examples of the sealant film include the same as that in the configuration (1). In the same manner as in the configuration (1), a printed layer described later may be provided on the surface of the substrate film 1 on the adhesive layer 1 side.

When the laminate of the present invention includes at least one of a metal-deposited film, a transparent vapor deposited film, and a metal layer, the adhesive layer in contact with the metal-deposited film, the transparent vapor-deposited layer, and the metal layer is preferably a cured coating film of the adhesive according to the present invention.

The adhesive according to the present invention is usually used as a two-part adhesive. Therefore, it is preferable to use a mixture of the oil and/or fat (A) containing an acid anhydride group and the curing agent (H) immediately before use. As described above, the blending ratio is preferably in a range of from 0.5 to 1.5, more preferably from 0.8 to 1.25 in terms of the molar ratio of the acid anhydride group of (A) and the functional group capable of reacting with the acid anhydride group of (H) (acid anhydride group/functional group capable of reacting with acid anhydride group). When the blending ratio of (A) and (H) is within the above range, a coating film excellent in adhesive strength can be obtained. When the curing agent (H) contains the amine compound (C), the amount of (C) used is preferably in a range of from 0.05 to 0.7, more preferably from 0.1 to 0.5 in terms of the molar ratio of nitrogen of (C) to the acid anhydride group of (A) (nitrogen/acid anhydride group). When the use amount of (C) is within the above range, an adhesive cured product excellent in adhesive strength can be obtained while securing a suitable pot life.

When the adhesive is used as a two-part adhesive as described above, the oil and/or fat (A) containing an acid anhydride group may be expressed as a main agent, and the curing agent (H) may be expressed as a curing agent.

When the adhesive according to the present invention is a solvent type adhesive, the laminate of the present invention is obtained by applying the adhesive according to the present invention onto the film material serving as a substrate using a roll such as a gravure roll, volatilizing the organic solvent through heating in an oven or the like, and then bonding the other substrate thereto. After the lamination, an aging treatment is preferably performed. An aging temperature is preferably from room temperature to 80° C., and an aging time is preferably from 12 to 240 hours.

When the adhesive according to the present invention is a solventless type adhesive, the laminate of the present invention is obtained by applying the adhesive according to the present invention heated to about from 40° C. to 100° C. in advance onto the film material serving as a substrate using a roll such as a gravure roll, and then immediately bonding the other substrate thereto. After the lamination, an aging treatment is preferably performed. The aging temperature is preferably from room temperature to 70° C., and the aging time is preferably from 6 to 240 hours.

When the adhesive according to the present invention is used as the adhesion auxiliary agent, the laminate of the present invention is obtained by applying the adhesion auxiliary agent according to the present invention onto the film material serving as a substrate using a roll such as a gravure roll, volatilizing the organic solvent through heating in an oven or the like, and then laminating the molten polymer material by an extruder.

A coating amount of the adhesive is appropriately adjusted. In the case of the solvent type adhesive, as an example, the coating amount is adjusted so that the amount of the solid content is 1 g/m² or more and 10 g/m² or less, preferably 1 g/m² or more and 5 g/m² or less. In the case of the solventless type adhesive, the coating amount of the adhesive is 1 g/m² or more and 10 g/m² or less, preferably 1 g/m² or more and 5 g/m² or less, as an example.

When the adhesive according to the present invention is used as the adhesion auxiliary agent, the coating amount is 0.03 g/m² or more and 0.09 g/m² or less (solid content), as an example.

### (Printed Layer)

The printed layer is a layer on which characters, figures, symbols, other desired patterns, and the like are printed. The printing method and the printing ink are not particularly limited, and known printing methods and printing inks can be used. As printing ink often used for the film used as the substrate, printing ink using a gravure printing method, a flexographic printing method, a lithographic offset printing method, an inkjet recording printing method, or the like is often used. In addition, a printing ink obtained by combining these printing methods with a method of curing with active energy rays such as ultraviolet rays (UV), LEDs, and electron beams (EB), a method of curing with heat, and the like is also used. Depending on the solvent to be used, the printing ink may be referred to as an aqueous ink or an organic solvent type ink.

Specific examples thereof include gravure printing inks and flexographic printing inks (the gravure printing ink and the flexographic printing ink may be referred to as liquid printing ink depending on the industry), ultraviolet curable inks for lithographic offset printing, electron beam curable inks for lithographic offset printing, ultraviolet curable inks for inkjet recording printing, and electron beam curable inks for inkjet recording printing.

In particular, a packaging material requiring recycling often has a printed layer using a liquid ink such as gravure ink or flexographic ink. The position where the laminate is provided is arbitrary. In the present specification, the liquid ink is a generic term for solvent type inks used for gravure printing or flexographic printing. The liquid ink may contain a resin, a colorant, and a solvent as essential components, or may be a so-called clear ink containing a resin and a solvent and substantially containing no colorant.

The resin used for the liquid ink is not particularly limited, and examples thereof include an acrylic resin, a polyester resin, a styrene resin, a styrene-maleic acid resin, a maleic acid resin, a polyamide resin, a polyurethane resin, a vinyl chloride-vinyl acetate copolymer resin, a vinyl chloride-acrylic copolymer resin, an ethylene-vinyl acetate copolymer resin, a vinyl acetate resin, a polyvinyl chloride resin, a chlorinated polypropylene resin, a cellulose-based resin, an epoxy resin, an alkyd resin, a rosin-based resin, a rosin-modified maleic acid resin, a ketone resin, a cyclized rubber, a rubber chloride, butyral, and a petroleum resin, and one type or two or more types can be used in combination. Preferably, at least one or two or more selected from a polyurethane resin, a vinyl chloride-vinyl acetate copolymer resin, and a cellulose-based resin are used.

Examples of the colorant used in the liquid ink include inorganic pigments such as titanium oxide, rouge, antimony red, cadmium red, cadmium yellow, cobalt blue, Prussian blue, ultramarine blue, carbon black, and graphite; organic pigments such as soluble azo pigments, insoluble azo pigments, azo lake pigments, condensed azo pigments, copper phthalocyanine pigments, and condensed polycyclic pigments; and extender pigments such as calcium carbonate, kaolin clay, barium sulfate, aluminum hydroxide, and talc.

The organic solvent used for the liquid ink preferably does not contain an aromatic hydrocarbon-based organic solvent. More specific examples thereof include alcohol-based organic solvents such as methanol, ethanol, n-propanol, isopropanol, and butanol, ketone-based organic solvents such as acetone, methyl ethyl ketone, and methyl isobutyl ketone, ester-based organic solvents such as methyl acetate, ethyl acetate, propyl acetate, and butyl acetate, aliphatic hydrocarbon-based organic solvents such as n-hexane, n-heptane, and n-octane, and alicyclic hydrocarbon-based organic solvents such as cyclohexane, methylcyclohexane, ethylcyclohexane, cycloheptane, and cyclooctane, and one type or two or more types can be used in combination.

### Primer Layer

A primer layer can be provided in order to facilitate fixing of the printed layer to a plastic film as a substrate and facilitate peeling of the printed layer by a treatment using an alkali solution which is currently the most general-purpose recycling treatment. The primer layer is particularly preferably a primer layer containing a urethane resin.

### <Urethane Resin (A)>

A urethane resin (PA) suitable for the primer layer used in the present invention includes a reaction product obtained by reacting (crosslinking/curing reaction) the aromatic polyester polyol (a1) with the polyisocyanate (a2). The urethane resin (PA) may further contain another polyol (a3) in addition to the aromatic polyester polyol (a1) and the polyisocyanate (a2), and may be a reaction product of the aromatic polyester polyol (a1), the polyisocyanate (a2), and the polyol (a3).

<<Aromatic Polyester Polyol (a1)>>

The aromatic polyester polyol (a1) can be produced by, for example, esterification reaction of an aromatic dicarboxylic acid (a1-1) with a polyol (a1-2).

Examples of the aromatic dicarboxylic acid (a1-1) that can be used in production of the aromatic polyester polyol (a1) include aromatic dicarboxylic acids such as terephthalic acid, isophthalic acid, orthophthalic acid, 1,4-naphthalenedicarboxylic acid, 2,5-naphthalenedicarboxylic acid, 2,6-naphthalenedicarboxylic acid, naphthalic acid, biphenyldicarboxylic acid, and 1,2-bis(phenoxy) ethane-P,P′-dicarboxylic acid, and acid anhydrides or ester-forming derivatives thereof, aromatic hydroxycarboxylic acids such as p-hydroxybenzoic acid and ester-forming derivatives thereof, and sulfonic acid group-containing aromatic dicarboxylic acids such as 5-sulfoisophthalic acid and ester-forming derivatives thereof.

In addition to the aromatic dicarboxylic acid (a1-1), an aliphatic carboxylic acid and an alicyclic carboxylic acid can be used in combination. Examples thereof include aliphatic dicarboxylic acids such as succinic acid, succinic anhydride, adipic acid, suberic acid, azelaic acid, sebacic acid, dimer acid, maleic anhydride, and fumaric acid, alicyclic dicarboxylic acids such as 1,4-cyclohexanedicarboxylic acid, anhydrides thereof, and ester-forming derivatives thereof. These may be used alone or in combination of two or more.

As the polyol (a1-2), for example, ethylene glycol, diethylene glycol, triethylene glycol, 1,2-propylene glycol, 1,3-propylene glycol, dipropylene glycol, 1,4-butanediol, 1,3-butanediol, 1,2-butanediol, 2,3-butanediol, 1,5-pentanediol, 1,5-hexanediol, 2,5-hexanediol, 1,6-hexanediol, 1,7-heptanediol, and neopentyl glycol can be used.

Specifically, the aromatic dicarboxylic acid (a1-1) and the polyol (a1-2) can be reacted under normal pressure or reduced pressure in a reaction vessel substituted with an inert gas such as nitrogen in the presence of a catalyst as necessary. The reaction is preferably carried out in a range of from 100° C. to 300° C.

As the catalyst, for example, an acetate of an alkali metal or an alkaline earth metal, a compound containing zinc, manganese, cobalt, antimony, germanium, titanium, tin, zirconium, and the like can be used. Among them, it is preferable to use tetraalkyl titanate or tin oxalate effective for transesterification reaction, polycondensation reaction, and the like.

When the urethane resin (PA) is produced, the aromatic polyester polyol (a1) and the polyisocyanate (a2) can be used in combination with another polyol (a3) and the like.

As the polyol (a3), a polyol similar to the polyol (a1-2) can be used, and for example, a polyol having a relatively low molecular weight such as ethylene glycol, diethylene glycol, triethylene glycol, 1,2-propylene glycol, 1,3-propylene glycol, dipropylene glycol, 1,4-butanediol, 1,3-butanediol, 1,2-butanediol, 2,3-butanediol, 1,5-pentanediol, 1,5-hexanediol, 2,5-hexanediol, 1,6-hexanediol, 1,7-heptanediol, and neopentyl glycol can be used.

<<Polyisocyanate (a2)>>

As the polyisocyanate (a2) which reacts with the polyol (a1) to form the urethane resin (PA), for example, aromatic diisocyanates such as phenylene diisocyanate, tolylene diisocyanate, diphenylmethane diisocyanate, and naphthalene diisocyanate, aliphatic or aliphatic cyclic structure-containing diisocyanates such as hexamethylene diisocyanate, lysine diisocyanate, cyclohexane diisocyanate, isophorone diisocyanate, dicyclohexylmethane diisocyanate, xylylene diisocyanate, and tetramethylxylylene diisocyanate, and the like can be used alone or in combination of two or more thereof. Among them, it is more preferable to use one or more selected from the group of isophorone diisocyanate, tolylene diisocyanate, hexamethylene diisocyanate, and dicyclohexylmethane diisocyanate from the viewpoint of improving the substrate adhesiveness and deinking properties of the primer layer to be obtained.

The urethane resin (PA) can be produced, for example, by reacting the aromatic polyester polyol (a1), the polyisocyanate (a2), the polyol (a3) as necessary, and a chain extender as necessary, in the absence of a solvent or in the presence of an organic solvent. When the organic solvent is used, the organic solvent is preferably removed by a method such as distillation as necessary when the urethane resin (PA) is dispersed in an aqueous medium(S).

As the organic solvent which can be used in production of the urethane resin (PA), for example, ketones such as acetone and methyl ethyl ketone; ethers such as tetrahydrofuran and dioxane; acetates such as ethyl acetate and butyl acetate; nitriles such as acetonitrile; dimethylformamide, N-methylpyrrolidone, and the like can be used alone or in combination of two or more.

The chain extender which can be used in production of the urethane resin (PA) can be used for the purpose of increasing the molecular weight of the urethane resin (PA) and improving the durability of the resulting film and the like.

As the chain extender which can be used in production of the urethane resin (PA), polyamine, other active hydrogen atom-containing compounds, and the like can be used.

As the polyamine, for example, it is possible to use diamines such as ethylenediamine, 1,2-propanediamine, 1,6-hexamethylenediamine, piperazine, 2,5-dimethylpiperazine, isophoronediamine, 4,4′-dicyclohexylmethanediamine, 3,3′-dimethyl-4,4′-dicyclohexylmethanediamine, and 1,4-cyclohexanediamine; N-hydroxymethylaminoethylamine, hydroxypropylaminopropylamine, methylaminopropylamine; diethylenetriamine, dipropylenetriamine, triethylenetetramine; hydrazine, N,N′-dimethylhydrazine, 1,6-hexamethylene bishydrazine; succinic acid dihydrazide, adipic acid dihydrazide, glutaric acid N-hydroxyethylaminoethylamine, N—N-ethylaminoethylamine, N-dihydrazide, sebacic acid dihydrazide, isophthalic acid dihydrazide; β-semicarbazidopropionic acid hydrazide, 3-semicarbazide-propyl-carbazate, and semicarbazide-3-semicarbazidomethyl-3,5,5-trimethylcyclohexane can be used, and ethylenediamine is preferably used.

As other active hydrogen-containing compounds, for example, glycols such as ethylene glycol, diethylene glycol, triethylene glycol, propylene glycol, 1,3-propanediol, 1,3-butanediol, 1,4-butanediol, hexamethylene glycol, neopentyl glycol, saccharose, methylene glycol, glycerin, and sorbitol; phenols such as bisphenol A, 4,4′-dihydroxydiphenyl, 4,4′-dihydroxydiphenyl ether, 4,4′-dihydroxydiphenyl sulfone, hydrogenated bisphenol A, and hydroquinone, water, and the like can be used.

The chain extender can be used when the aromatic polyester polyol (a1) and the polyisocyanate (a2) are reacted or after the reaction. When the urethane resin (PA) is dispersed in the aqueous medium(S) to be made aqueous, the chain extender can also be used.

### <<Characteristics of Urethane Resin (PA)>>

A concentration of an aromatic ring derived from the raw material monomer of the aromatic dicarboxylic acid (a1-1) in the urethane resin (PA) is 1 mmol/g or more.

The aromatic ring concentration is determined by calculating the number of moles of aromatic rings contained in 1 g of the urethane resin (PA).
A specific calculation method will be described later.
The aromatic ring concentration is preferably 1.5 mmol/g or more, more preferably 2 mmol/g or more from the viewpoint of improving the substrate adhesiveness and deinking properties of the resulting primer layer, and is preferably 6 mmol/g or less, more preferably 5 mmol/g or less from the viewpoint of good film-forming property of the primer layer.

An ester bond group concentration in the urethane resin (PA) is 1 mmol/g or more. The ester bond group concentration is determined by calculating the number of moles of the ester bonding groups contained in 1 g of the urethane resin (PA).

A specific calculation method will be described later.
The ester bond group concentration is preferably 2 mmol/g or more, more preferably 4 mmol/g or more from the viewpoint of improving the substrate adhesiveness and deinking properties of the resulting primer layer, and is preferably 9 mmol/g or less, more preferably 7 mmol/g or less from the viewpoint of good blocking resistance of the primer layer.

The acid value of the urethane resin (PA) is from 8 to 45 mgKOH/g. The acid value is a value obtained by converting an amount of an acid in 1 g of a resin, which is calculated by titrating an acid with an alkali, into the number of mg of potassium hydroxide, and is a value obtained in accordance with JISK0070.

When the acid value is 8 mgKOH/g or more, the aqueous dispersion stability can be improved, and the acid value is preferably 15 mgKOH/g or more, more preferably 20 mgKOH/or more. When the acid value is 45 mgKOH/g or less, the adhesiveness to the polyester substrate can be secured well, and the acid value is preferably 40 mgKOH/g or less, more preferably 30 mgKOH/or less.

A value obtained by dividing a mass of the raw material monomer of the polyisocyanate (a2) contained in 1 g of the urethane resin (PA) by an NCO equivalent weight of the raw material monomer of the polyisocyanate (a2) is preferably from 1.0 to 6.0 mmol/g.

When the value is 1.0 mmol/g or more, the substrate adhesiveness and deinking properties of the resulting primer layer can be improved, and the value is more preferably 1.5 mmol/g or more, and still more preferably 1.8 mmol/g or more. When the value is 6.0 mmol/g or less, the film-forming property of the primer layer can be secured, and the value is more preferably 5.0 mmol/g or less, and more preferably 4.0 mmol/g or less.

The weight average molecular weight of the urethane resin (PA) is preferably from 10,000 to 100,000. From the viewpoint of the blocking resistance to a substrate, hydrolysis resistance stability of the resin, and the like, the weight average molecular weight of the urethane resin (PA) is preferably 20,000 or more, and more preferably 30,000 or more. In addition, the weight average molecular weight is preferably 80,000 or less, and more preferably 60,000 or less, from the viewpoint of reducing the viscosity at the time of water dispersion, productivity, and the like.

In the present invention, the weight average molecular weight is a value as measured by gel permeation chromatography (GPC) under the following conditions.

Measurement apparatus: high-speed GPC apparatus (“HLC-8220GPC” available from Tosoh Corporation) Column:
The following columns available from Tosoh Corporation were connected in series and used.
“TSKgel G5000” (7.8 mm I.D.×30 cm)×1 column
“TSKgel G4000” (7.8 mm I.D.×30 cm)×1 column
“TSKgel G3000” (7.8 mm I.D.×30 cm)×1 column
“TSKgel G2000” (7.8 mm I.D.×30 cm)×1 column
Detector: RI (differential refractometer)
Column temperature: 40° C.
Eluent: tetrahydrofuran (THF)
Flow rate: 1.0 mL/min
Injection volume: 100 μL (tetrahydrofuran solution with a sample concentration of 0.4 mass %)
Standard sample: A calibration curve is created using the following standard polystyrenes.

### [Standard Polystyrene]

“TSKgel Standard Polystyrene A-500” available from Tosoh Corporation
“TSKgel Standard Polystyrene A-1000” available from Tosoh Corporation
“TSKgel Standard Polystyrene A-2500” available from Tosoh Corporation
“TSKgel Standard Polystyrene A-5000” available from Tosoh Corporation
“TSKgel Standard Polystyrene F-1” available from Tosoh Corporation
“TSKgel Standard Polystyrene F-2” available from Tosoh Corporation
“TSKgel Standard Polystyrene F-4” available from Tosoh Corporation
“TSKgel Standard Polystyrene F-10” available from Tosoh Corporation
“TSKgel Standard Polystyrene F-20” available from Tosoh Corporation
“TSKgel Standard Polystyrene F-40” available from Tosoh Corporation
“TSKgel Standard Polystyrene F-80” available from Tosoh Corporation
“TSKgel Standard Polystyrene F-128” available from Tosoh Corporation
“TSKgel Standard Polystyrene F-288” available from Tosoh Corporation
“TSKgel Standard Polystyrene F-550” available from Tosoh Corporation

A glass transition temperature of the urethane resin (PA) is preferably from 0 to 110° C.

### <Aqueous Medium (S)>

The urethane resin (PA) is preferably present in the aqueous medium. Examples of the aqueous medium(S) serving as a solvent include water, an organic solvent miscible with water, and a mixture thereof.

Examples of the organic solvent miscible with water include alcohols such as methanol, ethanol, n-, and isopropanol; ketones such as acetone and methyl ethyl ketone; polyalkylene glycols such as ethylene glycol, diethylene glycol, and propylene glycol; alkyl ethers of polyalkylene glycols; and N-methyl-2-pyrrolidone.
In the present invention, only water may be used, a mixture of water and an organic solvent miscible with water may be used, or only the organic solvent miscible with water may be used. From the viewpoint of safety and environmental load, only water or the mixture of water and the organic solvent miscible with water is preferable, and only water is particularly preferable.

When the urethane resin (PA) is water dispersed in the aqueous medium(S), a machine such as a homogenizer can be used as necessary.

The aqueous urethane resin composition suitable for the primer layer used in the present invention contains the urethane resin (PA) in an amount of preferably from 5 mass % to 50 mass %, more preferably from 10 mass % to 25 mass % with respect to a total amount of the aqueous urethane resin composition. The aqueous medium(S) is contained in an amount of preferably from 50 mass % to 95 mass %, more preferably from 75 mass % to 90 mass % with respect to a total amount of the urethane resin composition.

### <Other Additives>

For the aqueous urethane resin composition suitable for the primer layer used in the present invention, various additives such as a film-forming aid, a crosslinking agent, a curing accelerator, a plasticizer, an antistatic agent, a wax, a light stabilizer, a flow regulator, a dye, a leveling agent, a rheology control agent, an ultraviolet absorber, an antioxidant, a photocatalytic compound, an inorganic pigment, an organic pigment, and an extender pigment, and the like can be used as necessary.

Among the additives, the emulsifier and the leveling agent may cause a decrease in durability of the resulting film and the like, and therefore when high durability is required for the film and the like, the emulsifier and the leveling agent are preferably used in an amount of 5 mass % or less with respect to the total amount of the aqueous urethane resin composition.

In the aqueous urethane resin composition suitable for the primer layer used in the present invention, various crosslinking agents can be used in combination for forming a film and the like excellent in durability. As the crosslinking agent, for example, an isocyanate-based crosslinking agent, an epoxy-based crosslinking agent, an amino-based crosslinking agent, an aziridine-based crosslinking agent, a silane coupling agent-based crosslinking agent, a carbodiimide-based crosslinking agent, an oxazolidine-based crosslinking agent, and the like can be used.

The crosslinking agent is used in an amount of preferably 30 mass % or less, more preferably 20 mass % or less with respect to the total amount of the urethane resin (PA) from the viewpoint of improving the adhesiveness to a substrate, improving the deinking properties, and the like. The crosslinking agent is preferably mixed and used immediately before the aqueous urethane resin composition according to the present invention is applied.

### Primer Layer

The aqueous urethane resin composition suitable for the primer layer used in the present invention can be applied onto the substrate to form a primer layer.

The aqueous urethane resin composition according to the present invention can be applied onto the substrate using a known printing method such as gravure printing or flexographic printing. At the time of printing, the aqueous urethane resin composition is diluted with a dilution solvent in which an aqueous solution, for example, an alcohol-based organic solvent such as ethyl alcohol, isopropyl alcohol, or normal propyl alcohol and water are mixed to a viscosity and a concentration suitable for a gravure printing method or a flexographic printing method, and supplied to each printing unit alone or in combination.

The method for applying the aqueous urethane resin composition onto the substrate can also be performed by an in-line coating method in which the aqueous urethane resin composition is applied in the middle of a stretching step (for example, a biaxial stretching step) of the substrate and then further subjected to a stretching step, or by using an off-line coating method in which the aqueous urethane resin composition is applied and dried after the stretching step (for example, a biaxial stretching step) of the substrate to form a primer layer.

A printed layer including a printing ink composition can be formed on the primer layer.

The primer layer can be easily detached by treatment with an alkali solution. Since the primer layer is easily peeled off from the substrate, the printed layer formed on the primer layer can also be easily removed from the substrate.

### (Other Layers)

In the laminate of the present invention, other films and substrates may be further included in addition to the laminates (1) to (10) described above in applications that do not require recycling. As the additional substrate, in addition to the stretched film, unstretched film, and transparent vapor-deposited film described above, a porous substrate such as paper described later, wood, or leather can be used. The adhesive used at the time of bonding the additional substrate may or may not be the adhesive according to the present invention.

The paper is not particularly limited, and a known paper substrate can be used. Specifically, it is produced by a known papermaking machine using natural fibers for papermaking such as wood pulp, and papermaking conditions are not particularly limited. Examples of the natural fibers for papermaking include wood pulp such as softwood pulp and hardwood pulp, non-wood pulp such as manila hemp pulp, sisal hemp pulp and flax pulp, and pulp produced by subjecting these pulps to chemical modification. Examples of usable pulp type include chemical pulp produced by a sulfate-cooking method, an acid-neutral-alkaline sulfite-cooking method, a soda-salt-cooking method, and the like, ground pulp, chemiground pulp, and thermomechanical pulp.

In addition, various commercially available high-quality papers, coated papers, backing papers, impregnated papers, cardboard, paperboard, and the like can also be used.

A printed layer may be provided on an outer surface or an inner surface side of a paper layer as necessary.

The laminate of the present invention can be suitably used for various applications, for example, packaging materials for foods, pharmaceuticals, and daily necessities, a lid material, paper tableware such as a paper straw, a paper napkin, a paper spoon, a paper dish, and a paper cup, outdoor industrial applications for a barrier material, a roof material, a solar cell panel material, a battery packaging material, a window material, an outdoor flooring material, a lighting protection material, an automobile member, a signboard, a sticker, and the like, a decorative sheet used for an injection molding simultaneous decorating method and the like, and packaging materials for a liquid detergent for laundry, a liquid detergent for kitchens, a liquid detergent for baths, a liquid shampoo, a liquid conditioner, and the like.

### Packaging Material

The laminate of the present invention can be used as a multilayer packaging material for the purpose of protecting foods, pharmaceuticals, and the like. When used as the multilayer packaging material, the layer configuration may vary depending on the contents, use environment, and use form. The packaging material of the present invention may be appropriately provided with an easy-to-unseal treatment or a resealing means.

The packaging material of the present invention can be obtained by using the laminate of the present invention, overlapping the laminates so that the sealant film surfaces thereof face each other, and then heat-sealing peripheral ends thereof to form a bag. Examples of a bag-making method include a method in which the laminate of the present invention is folded or the laminates are overlapped so that the inner layer surfaces (sealant film surfaces) thereof face each other, and peripheral ends thereof are heat sealed, for example, in a side seal type, a two-side seal type, a three-side seal type, a four-side seal type, an envelope seal type, a butt-seam seal type, a pleated seal type, a flat bottom seal type, a square bottom seal type, a gusset type or any other heat seal type form. The packaging material of the present invention may take various forms depending on the contents, use environment, and use form. Self-standing packaging materials (standing pouches) and the like are also possible. The heat sealing may be performed by a known method such as bar sealing, rotary roll sealing, belt sealing, impulse sealing, high-frequency sealing or ultrasonic sealing.

A product using the packaging material of the present invention is produced by filling the packaging material of the present invention with contents through its opening and then heat-sealing the opening. As the content to be filled, examples of foods include confectioneries such as rice confectionery, bean confectionery, nuts, biscuit, cookie, wafers, marshmallow, pie, rare cake, candy, and snack; staples such as bread, snack noodle, instant noodle, dried noodle, pasta, sterile packaged cooked rice, rice porridge, rice gruel, packaged rice cake, and cereal foods; agricultural processed foods such as pickle, boiled bean, natto (fermented soybean), miso, frozen tofu, tofu, nametake, konjak, processed wild vegetable products, jams, peanut cream, salad, frozen vegetables, and processed potato products; processed livestock products such as ham, bacon, sausage, processed chicken products, and corned beef; processed marine products such as fish meat ham, sausage, fish paste products, boiled fish paste, toasted layer, soy-boiled foods, dried bonito, salted fish gut, smoked salmon and salted cod roe; fruits such as peach, orange, pineapple, apple, pear, and cherry; vegetables such as corn, asparagus, mushroom, onion, carrot, radish, and potato; cooked foods such as frozen daily dishes and chilled daily dishes represented by hamburger, meat ball, fried sea foods, gyoza (dumpling stuffed with minced pork), croquette, and the like; dairy products such as butter, margarine, cheese, cream, instant creamy powder, and childcare conditioned powdered milk; and foods such as liquid seasonings, retort curry, and pet foods.

As non-food products, the packaging material can also be used as various packaging materials such as pharmaceuticals such as cigarettes, a disposable body warmer, and a transfusion pack, liquid detergents for laundry, liquid detergents for kitchens, liquid detergents for baths, liquid soaps for baths, liquid shampoos, liquid conditioners, cosmetics such as lotion and emulsion, vacuum insulation materials, and batteries.

### (Method for Separating and Recovering Laminate)

In the laminate of the present invention, it is possible to separate and recover the laminate into each substrate by the treatment using an alkali solution which is currently the most general-purpose recycling treatment. For example, the laminate can be separated and recovered by immersing the laminate in the alkali solution while heating and stirring the laminate at from 20 to 90° C.

The alkali solution used in the separation and recovery method is preferably a sodium hydroxide aqueous solution, a potassium hydroxide aqueous solution, or the like. The sodium hydroxide aqueous solution and the potassium hydroxide aqueous solution are preferably aqueous solutions having a concentration of from 0.5 mass % to 10 mass %, and more preferably aqueous solutions having a concentration of from 1 mass % to 5 mass %. The PH is preferably 10 or more.

The alkali solution may contain a water-soluble organic solvent. Examples of the water-soluble organic solvent include methyl alcohol, ethyl alcohol, propyl alcohol, isopropyl alcohol, ethylene glycol monomethyl ether (methyl cellosolve), ethylene glycol monoethyl ether (cellosolve), ethylene glycol monobutyl ether (butyl cellosolve), ethylene glycoldibutyl ether, diethylene glycol monomethyl ether (methyl carbitol), diethylene glycol dimethyl ether, diethylene glycol monoethyl ether (carbitol), diethylene glycol diethyl ether (diethyl carbitol) diethylene glycol monobutyl ether (butyl carbitol), diethylene glycol dibutyl ether, triethylene glycol monomethyl ether, triethylene glycol dimethyl ether, tetraethylene glycol dimethyl ether, methylene dimethyl ether (methylal), propylene glycol monobutyl ether, tetrahydrofuran, acetone, diacetone alcohol, acetonyl acetone, acetyl acetone, ethylene glycol monomethyl ether acetate (methyl cellosolve acetate), diethylene glycol monomethyl ether acetate (methyl carbitol acetate), diethylene glycol monoethyl ether acetate (carbitol acetate), ethyl hydroxyisobutyrate, and ethyl lactate, and these water-soluble organic solvents can be used singly or two or more water-soluble organic solvents can be combined together and used.

A content ratio of the water-soluble organic solvent in the alkali solution is preferably from 30 mass % to 70 mass %, and more preferably from 40 mass % to 60 mass %.

The alkali solution may contain a water-insoluble organic solvent. Specific examples of the water-insoluble organic solvent include alcohol-based solvents such as n-butanol, 2-butanol, isobutanol, and octanol, aliphatic hydrocarbon-based solvents such as hexane, heptane, and normal paraffin, aromatic hydrocarbon-based solvents such as benzene, toluene, xylene, and alkylbenzene, halogenated hydrocarbon-based solvents such as methylene chloride, 1-chlorobutane, 2-chlorobutane, 3-chlorobutane, and carbon tetrachloride, ester-based solvents such as methyl acetate, ethyl acetate, and butyl acetate, ketone-based solvents such as methyl isobutyl ketone, methyl ethyl ketone, and cyclohexanone, and ether-based solvents such as ethyl ether and butyl ether, and these water-insoluble organic solvents can be used singly or two or more water-insoluble organic solvents can be combined together and used.

The alkali solution may contain a surfactant. Examples of the surfactant include various anionic surfactants, nonionic surfactants, cationic surfactants, and amphoteric surfactants, and, among these, anionic surfactants and nonionic surfactants are preferable.

Examples of the anionic surfactants include alkylbenzene sulfonate, alkylphenyl sulfonate, alkylnaphthalens sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkyl ether carboxylate, polyoxyethylene alkyl ether sulfate, alkyl phosphate, and polyoxyethylene alkyl ether phosphate, and, as specific examples thereof, dodecylbenzene sulfonate, isopropylnaphthalene sulfonate, monobutylphenylphenol monosulfonate, monobutylbiphenylsulfonate, dibutylphenylphenol disulfonate, and the like can be exemplified.

Examples of the nonionic surfactant include polyoxyethylene alkyl ethers, polyoxyethylene alkylphenyl ethers, polyoxyethylene fatty acid esters, sorbitan fatty acid esters, polyoxyethylene sorbitan fatty acid esters, polyoxyethylene sorbitol fatty acid esters, glycerin fatty acid esters, polyoxyethylene glycerin fatty acid esters, polyglycerin fatty acid esters, sucrose fatty acid esters, polyoxyethylene alkylamines, polyoxyethylene fatty acid amides, fatty acid alkylolamides, alkylalkanolamides, acetylene glycol, oxyethylene adducts of acetylene glycol, and polyethylene glycol-polypropylene glycol block copolymers. Among these, polyoxyethylene nonylphenyl ether, polyoxyethylene octylphenyl ether, polyoxyethylene dodecylphenyl ether, polyoxyethylene alkyl ethers, polyoxyethylene fatty acid esters, sorbitan fatty acid esters, polyoxyethylene sorbitan fatty acid esters, fatty acid alkylolamides, acetylene glycol, oxyethylene adducts of acetylene glycol, and polyethylene glycol-polypropylene glycol block copolymers are preferable.

As other surfactants, it is also possible to use silicone-based surfactants such as polysiloxane oxyethylene adduct; fluorine-based surfactants such as perfluoroalkyl carboxylate, perfluoroalkyl sulfonates, and oxyethylene perfluoroalkyl ether; biosurfactants such as spicullisporic acid, rhamnolipid, and lysolecithin; and the like.

These surfactants may be used alone or as a mixture of two or more types. When the surfactant is added, the addition amount thereof is in a range of preferably from 0.001 to 2 mass %, more preferably from 0.001 to 1.5 mass %, and still more preferably from 0.01 to 1 mass % with respect to a total amount of the alkali solution.

In a state where the alkali solution is heated to from 20 to 90° C., for example, in a treatment tank, the target laminate is immersed. At this time, heating or ultrasonic waves may be applied. The heating method is not particularly limited, and it is possible to adopt a well-known heating method using heat rays, infrared rays, microwaves, or the like. In addition, for the ultrasonic vibration, it is possible to adopt, for example, a method in which an ultrasonic vibrator is attached to the treatment tank and ultrasonic vibrations are imparted to the alkali solution.

At the time of immersion, the alkali solution is preferably stirred. Examples of the stirring method include a method in which a dispersion liquid of the laminate stored in the treatment tank is mechanically stirred with a stirring blade, a method in which the alkali solution is stirred with water flows using a water flow pump, and a bubbling method with an inert gas such as nitrogen gas, and these methods may be used in combination in order to efficiently peel a multilayered film.

The time during which the laminate is immersed in the alkali solution also depends on the constitution of the laminate, but is typically from 2 minutes to 48 hours in many cases. When the immersion time is less than 2 minutes, there is a concern that an adhesive layer may not completely peel off from the laminate and may partially remain. Regarding the number of times of immersion in the alkali solution, the laminate may be immersed once or several times separately.

In most cases, the laminate is provided with a printing ink layer for providing display of a product name and the like and decorativeness in addition to an adhesive; however, in the step of immersing the laminate in the alkali solution, the printing ink layer can also be peeled off or dissolved. In some cases, a metal foil such as aluminum or a vapor-deposited film is stacked. In the present invention, the metal foil or the vapor-deposited film can also be detached or dissolved.

It is presumed that the alkali solution used in the separation and recovery method acts on the interface between the laminate and the adhesive or the printing ink to significantly reduce the adhesive force, thereby causing interfacial detachment between the laminate and the adhesive or the printing ink. Usually, a coating film after crosslinking such as a reactive adhesive is hardly dissolved in any solution; however, in the present invention, the coating film is not dissolved but interfacial peeling occurs, so that it is presumed that separation and recovery can be efficiently performed in a short time.

### (Recycled Plastic)

A collected product obtained by separating the laminate of the present invention into each substrate as described above, and the laminate and the packaging material of the present invention can be directly processed by various known recycled plastic processing methods to produce a recycled plastic. As an example of a specific aspect, a recycled plastic can be obtained by a production method including a step of crushing a recovered product obtained by separating the laminate of the present invention into each substrate or the laminate and the packaging material of the present invention, a step of melt-kneading crushed film pieces, and a step of pelletizing the melt-kneaded product.

A crusher used at the time of crushing (pulverization) is not particularly limited as long as a known crusher is used.

The film piece after pulverization is physically blended by melt-kneading, solvent cast blending, latex blending, polymer complex, and the like. In particular, a melt-kneading method is generally used. Examples of the device for kneading include a tumbler, a Henschel mixer, a rotary mixer, a super mixer, a ribbon tumbler, and a V blender. After melt-kneading is performed by such a kneading device, pelletization is performed. A uniaxial or multiaxial extruder is generally used for melt-kneading pelletization, and the film piece may be charged as it is, or may be charged after compression volume reduction treatment by heating or non-heating. In addition to these extruders, a Banbury mixer, a roller, a co-kneader, a blast mill, a prabender brought graph, and the like can also be used, and these are operated in batch or continuous. Alternatively, a method may be employed in which the film piece is used as a molding resin and is melt-kneaded in a molding machine heating cylinder without melt-kneading.

### EXAMPLES

Hereinafter, the details and effects of the present invention will be described in more detail with reference to Examples. In the examples, “part(s)” means “part(s) by mass”.

### Production Example 1 [Synthesis of Oil and/or Fat (A-1) Containing Acid Anhydride Group]

A flask equipped with a stirrer, a thermometer, and a nitrogen gas introduction tube was charged with 1000 parts of tung oil, and the temperature was raised to 100° C. Next, 250 parts of maleic anhydride was charged in five times and further reacted for 3 hours to obtain an oil and/or fat (A-1) containing an acid anhydride group.

### Production Example 2 [Synthesis of Oil and/or Fat (A-2) Containing Acid Anhydride Group]

A flask equipped with a stirrer, a thermometer, and a nitrogen gas introduction tube was charged with 1000 parts of linseed oil and 100 parts of maleic anhydride, and the temperature was raised to 180° C. The mixture was reacted at 180° C. for 2 hours, then 125 parts of maleic anhydride was added, and the temperature was raised to 200° C. and further reacted for 3 hours, thereby obtaining an oil and/or fat (A-2) containing an acid anhydride group.

### Production Example 3 [Synthesis of Oil and/or Fat (A-3) Containing Acid Anhydride Group]

A flask equipped with a stirrer, a thermometer, and a nitrogen gas introduction tube was charged with 800 parts of soybean oil, 225 parts of maleic anhydride, and 0.5 parts of phosphoric acid, and the temperature was raised to 180° C. The mixture was reacted at 180° C. for 3 hours, then the temperature was lowered to 100° C., 200 parts of tung oil was added, and the mixture was further reacted for 3 hours to obtain an oil and/or fat (A-3) containing an acid anhydride group.

### Production Example 4 [Synthesis of Polyester Polyol (B3-1)]

A polyester reaction vessel equipped with a stirrer, a thermometer, a nitrogen gas introduction tube, a rectification tube, a moisture separator, and the like was charged with 124 parts of ethylene glycol, 216 parts of diethylene glycol, 150 parts of neopentyl glycol, 590 parts of adipic acid, 70 parts of “TSUNODYME 216” (mixture of monool, diol, and triol of dimer acid mainly composed of dimer acid diol available from TSUNO CO., LTD.), and 0.1 parts of tetraisopropyl titanate, and the mixture was gradually heated so that an upper temperature of the rectification tube did not exceed 100° C. to maintain the internal temperature at 240° C. When the acid value reached 2.0 (mg-KOH/g) or less, the esterification reaction was completed to obtain a polyester polyol (B3-1). The hydroxyl value was 149 (mg-KOH/g).

### Production Examples 5 to 6 [Synthesis of Polyester Polyols (B3-2) to (B3-3)]

Polyester polyols (B3-2) to (B3-3) were obtained in the same manner as in Production Example 4 except that the raw materials used were changed as shown in Table 1.

TABLE 1
In Table 1, the blank represents being not blended.

| Raw material name | B3-1 | B3-2 | B3-3 |
|---|---|---|---|
| Ethylene glycol | 12.4 | 5 | 5 |
| Diethylene glycol | 21.6 | 44.7 | 34.5 |
| Neopentyl glycol | 15 | | |
| 1,6 Hexanediol | | | |
| Glycerol | | 4.5 | 12 |
| TSUNODYME 216 | 7 | | 7 |
| Adipic acid | 59 | 60.7 | 46.5 |
| Terephthalic acid | | | |
| Isophthalic acid | | | 10 |
| Hydroxyl value | 149 | 181 | 236 |
| Acid value | 1.9 | 1.9 | 1.7 |

### Production Example 7 [Synthesis of Acid-Modified Polyester Polyol (B-1)]

A polyester reaction vessel equipped with a stirrer, a thermometer, a nitrogen gas introduction tube, a rectification tube, and the like was charged with 1000 parts of the polyester polyol (B3-1) obtained in Production Example 4 and 20 parts of trimellitic anhydride, and the mixture was reacted at an internal temperature of 170° C. for 4 hours to obtain an acid-modified polyester polyol (B-1). The hydroxyl value was 141 (mg-KOH/g) and the acid value was 13.3 (mg-KOH/g).

### Production Examples 8 to 9 [Synthesis of Acid-Modified Polyester Polyols (B-2) to (B-3)]

Polyester polyols (B-2) to (B-3) were obtained in the same manner as in Production Example 7 and in the same manner as in Production Example 4 except that the raw materials used were changed as shown in Table 2.

TABLE 2
Acid-modified polyester polyol

| | | B-1 | B-2 | B-3 |
|---|---|---|---|---|
| Raw material polyester polyol | Type | B3-1 | B3-2 | B3-3 |
| Raw material polyester polyol | Blending amount | 100 | 100 | 100 |
| Raw material trimellitic | Blending amount | 2 | 4 | 4 |
| anhydride | | | | |
| Acid-modified polyester polyol | Hydroxyl value | 141 | 163 | 216 |
| | Acid value | 13.3 | 24.3 | 24.1 |
| | Weight average | 3100 | 3200 | 3800 |
| | molecular weight | | | |

### Production Example 10 [Preparation Examples of Curing Agents (H-2) to (H-5) and (H-H1)]

Various compounds were mixed at ratios shown in Table 3 to prepare curing agents (H-2) to (H-5) and a curing agent (H-H1) for Comparative Examples.

TABLE 3
Raw material name

| | | H-2 | H-3 | H-4 | H-5 | H-H1 |
|---|---|---|---|---|---|---|
| Polyester polyol | B3-1 | | | 10 | | 20 |
| Acid-modified polyol (B) | B-1 | 13 | 17 | 6.5 | 20 | |
| Acid-modified polyol (B) | B-2 | 20 | | 10 | | |
| Acid-modified polyol (B) | B-3 | | 12 | | 12 | |
| Polyol | PK-400GD | | | 1 | | 2 |
| Polyol | Gly | 1 | | 1.5 | | 2 |
| Amine compound (C) | T-403 | | | | 1 | |
| Amine compound (C) | EDP-300 | | 7.5 | | 5 | |
| Amine compound (C) | EDP-450 | 7.5 | | 7.5 | | 7.5 |
| | Total of blending | 41.5 | 36.5 | 36.5 | 38 | 31.5 |
| | amounts | | | | | |
| Curing agent | Hydroxyl value | 257 | 290 | 296 | 241 | 347 |
| | Acid value | 15.9 | 14.1 | 9.5 | 14.6 | 1.2 |

In Table 3, the blank represents being not blended. The abbreviations are as follows.
PK-400GD: Sunnix PK-400GD (bifunctional polypropylene glycol available from Sanyo Chemical Industries, Ltd., molecular weight: 417)
Gly: Glycerin
T-403: JEFFAMINE T-403 (trifunctional polyether polyamine available from Huntsman Corporation (USA), molecular weight: 440)
EDP-300: Adeka polyether EDP-300 (available from ADEKA Corporation, polypropylene glycol containing two tertiary amines in the molecule, molecular weight: 300, OHV: 750)
EDP-450: Adeka polyether EDP-450 (available from ADEKA Corporation, polypropylene glycol containing two tertiary amines in the molecule, molecular weight: 450, OHV: 500)

### Production Example 11 [Synthesis of Polyisocyanate Compound (E)]

A flask equipped with a stirrer, a thermometer, and a nitrogen gas introduction tube was charged with 50 parts of Lupranete MI (mixture of 4,4′-diphenylmethane isocyanate/2,4-diphenylmethane diisocyanate=50/50 available from BASF INOAC Polyurethanes Ltd.) and heated to 60° C. After 50 parts of a mixture of polypropylene glycol having a molecular weight of 1000/polypropylene glycol having a molecular weight of 2000=20/30 (weight ratio) was gradually added thereto in four times, the temperature was raised to 80° C., and the mixture was further reacted for 5 hours to obtain a polyisocyanate compound (E). NCO % of the obtained polyisocyanate compound (E) was 13.8%.

### Production Example 12 [Synthesis of Polyurethane Resin (PU) for Deinking Primer]

A polyester reaction vessel equipped with a stirrer, a thermometer, a nitrogen gas introduction tube, a rectification tube, and the like was charged with 320 g of terephthalic acid, 320 parts of isophthalic acid, 130 parts of ethylene glycol, and 230 parts of diethylene glycol, and the mixture was gradually heated so that the upper temperature of the rectification tube did not exceed 100° C. to maintain the internal temperature at 240° C. When the acid value reached 2.0 (mg-KOH/g) or less, the esterification reaction was completed to obtain a polyester polyol (P). The aromatic ring concentration was 3.8 mmol/g, the ester bond group concentration was 8.9 mmol/g, and the hydroxyl value was 49 (mg-KOH/g).

Next, a four-necked flask equipped with a stirrer, a thermometer, a reflux condenser, and a nitrogen gas introduction tube was charged with 740 parts of the polyester polyol (P), 200 parts of isophorone diisocyanate, and 60 parts of 2,2′-dimethylolpropionic acid at a ratio, and the mixture was reacted at 75° C. for 8 hours under a nitrogen stream to obtain a polyurethane resin (PU). In the polyurethane resin (PU), the concentration of an aromatic ring derived from a raw material monomer of aromatic dicarboxylic acid was 2.8 mmol/g, the ester bond group concentration was 6.6 mmol/g, and the acid value was 25 mgKOH/g. Ammonia was used as a neutralizing agent, and dilution was performed with water after neutralization so that a neutralizing agent/acid equivalent ratio was 1.05 to obtain an aqueous dispersion of a polyurethane resin.

### (Method for Producing Composition for Primer Layer)

As a composition for a primer layer, a composition obtained by mixing 3 parts of “Bayhydur Ultra BU3100” available from Covestro AG with 100 parts of the urethane resin (PU), and then diluting the mixture with isopropyl alcohol (IPA) to a solid content of 10% was used.

(Method for Producing Substrate with Primer Layer)

Using a gravure printer (DIC Engineering INC.) equipped with a gravure plate having a cell depth of 22 μm, a composition for a primer layer was printed on a stretched polypropylene (sometimes abbreviated as OPP) film subjected to gravure printing in a solid state with a white printing ink (“Finart R 794 white” available from DIC Corporation). Thereafter, the printing was dried at 100° C. for 10 minutes, and then allowed to stand at room temperature for 1 day to obtain a substrate 1 with a primer layer.

### Examples and Comparative Examples (Examples 1 to 6 and Comparative Examples 1 to 3)

According to the formulation shown in Tables 4 and 5, the oil and/or fat (A) containing an acid anhydride group and the curing agent (H) were blended to prepare an adhesive composition, and various evaluations were performed.

### (Method for Producing Laminate)

### (1) Method for Producing OPP/CPP Laminate

Using a laminator with a lamination speed set to 250 m/min, each prepared adhesive composition was applied to a stretched polypropylene (sometimes abbreviated as OPP) film subjected to gravure printing in a solid state with a white printing ink (“Finart R 794 white” available from DIC Corporation) such that the coating amount had a solid content of approximately 1.8 g/m², bonded to an unstretched polypropylene (sometimes abbreviated as CPP) film, and cured at 40° C. for 4 days to prepare a laminate obtained by stacking an OPP film, a white printing ink layer, an adhesive agent layer and a CPP film layer. This configuration is abbreviated as OPP/CPP.

### (2) Method for Producing Substrate 1/CPP Laminate

Using a laminator with a lamination speed set to 250 m/min, each prepared adhesive composition was applied to the substrate 1 such that the coating amount had a solid content of approximately 1.8 g/m², bonded to an unstretched polypropylene (sometimes abbreviated as CPP) film, and cured at 40° C. for 4 days to prepare a laminate obtained by stacking the substrate 1, a white printing ink layer, an adhesive agent layer, and a CPP film layer. This configuration is abbreviated as substrate 1/CPP.

### (3) Method for Producing NK/PBS Laminate

Using a laminator with a lamination speed set to 250 m/min, each prepared adhesive composition was applied to NaturflexNK (biodegradable film available from Futamura Chemical Co., Ltd.) such that the coating amount had a solid content of approximately 1.8 g/m², bonded to a PBS film (polybutylene succinate available from Mitsubishi Chemical Corporation), and cured at 40° C. for 4 days to prepare a laminate obtained by stacking NaturflexNK, an adhesive agent layer, and a PBS film layer. This configuration is abbreviated as NK/PBS.

### (4) Method for Producing Film for Biodegradability Evaluation

Using a laminator with a lamination speed set to 250 m/min, each prepared adhesive composition was applied onto a polyethylene terephthalate film such that the coating amount had a solid content of approximately 1.8 g/m², and cured at 40° C. for 4 days to prepare a film for biodegradability evaluation.

### (Adhesive Strength)

After the obtained laminate was aged at 40° C. for 4 days, a test piece having a width of 15 mm was prepared, and T-type peeling strength was measured at 25° C. at a peeling rate of 300 mm/min.
4: Adhesive strength>1.2 N
3: Adhesive strength of from 0.8 to 1.2 N (practical level)
2: Adhesive strength of from 0.5 to 0.8 N
1: Adhesive strength<0.5 N

### (Recycling Test)

A test piece having a size of 2 cm×2 cm was cut out from the laminate having an OPP/CPP configuration for Examples 1 to 4 and a substrate 1/CPP configuration for Examples 5 and 6, immersed in 50 g of an alkali solution of 2% sodium hydroxide (the solvent of the alkali solution is described in the table) at 70° C., and stirred at 400 rpm, and the presence or absence of peeling of the adhesive agent layer from the CPP film was measured for the time required for peeling of each laminate.

### (Laminate Peeling)

5: Peeling within 15 minutes (very excellent)
4: Peeling within 30 minutes (excellent), 4 or more is desirable.
3: Peeling within 1 hour
2: Peeling within 2 hours
1: No peeling even after a lapse of 2 hours

### (Peeling of Adhesive Agent Layer)

Peeling was evaluated with a ratio (residual ratio) of the adhesive remaining on the CPP film. The residual ratio of the adhesive was calculated from a height of an absorption peak of the ester bond of 1740 cm-1 based on the IR measurement result of the film before the test by measuring the IR of the film after the test by FT-IR.
5: Less than 5% (very excellent)
4: From 5 to 20% (practical level)
3: From 20 to 60% (unsuitable for practical use)
2: From 60 to 80%
1: >80%

### (Biodegradability)

Compost degradability was measured by a method in accordance with JIS K6953-1:2011 using the film for biodegradability evaluation.
Culture temperature: 58° C., culture period: 28 days
Evaluation criteria:
5: Compost degradation rate of 50% or more
4: Compost degradation rate of 40% or more and less than 50%
3: Compost degradation rate of 25% or more and less than 40%
2: Compost degradation rate of 15% or more and less than 25% (practical lower limit)
1: Compost degradation rate of less than 15% (unsuitable for practical use)

The results are shown in Tables 4 and 5.

TABLE 4

| | | Example | Example | Example | Example | Example | Example |
|---|---|---|---|---|---|---|---|
| | | 1 | 2 | 3 | 4 | 5 | 6 |
| Adhesive · | Type | A-1 | A-3 | A-2 | A-1 | A-2 | A-3 |
| main agent | Blending | 100 | 100 | 100 | 100 | 100 | 100 |
| | amount | | | | | | |
| Adhesive · | Type | H-3 | H-2 | H-4 | H-5 | H-2 | H-3 |
| curing agent | Blending | 40 | 41.5 | 36.5 | 42 | 41.5 | 36.5 |
| | amount | | | | | | |
| | Curing | 14.1 | 15.9 | 9.5 | 14.6 | 15.9 | 14.1 |
| | agent acid | | | | | | |
| | value | | | | | | |
| Adhesive | OPP/CPP | 4 | 4 | 4 | 4 | — | — |
| strength | Substrate | — | — | — | — | 3 | 3 |
| | 1/CPP | | | | | | |
| | NK/PBS | 4 | 4 | 4 | 4 | 4 | 4 |
| Recyclability | Solvent | Water | Water | Water | Water/ | Water | Water/ |
| | used in | | | | ethanol = | | ethanol = |
| | alkali | | | | 50/50 | | 50/50 |
| | solution | | | | | | |
| | Peeling of | 4 | 4 | 4 | 5 | 5 | 5 |
| | composite | | | | | | |
| | film | | | | | | |
| | Peeling of | 4 | 4 | 4 | 5 | 5 | 5 |
| | adhesive | | | | | | |
| | agent layer | | | | | | |
| Biodegradability | | 4 | 5 | 4 | 4 | 4 | 4 |

TABLE 5

| | | Comparative | Comparative | Comparative |
|---|---|---|---|---|
| | | Example 1 | Example 2 | Example 3 |
| Adhesive · | Type | E | E | A-1 |
| main agent | Blending amount | 100 | 100 | 100 |
| Adhesive · | Type | B3-2 | B-2 | H-H1 |
| curing agent | Blending amount | 70 | 70 | 31.5 |
| | Curing agent acid | 1.9 | 24.3 | 1.2 |
| | value | | | |
| | OPP/CPP | 4 | 4 | 3 |
| Adhesive | NK/PBS | 3 | 3 | 3 |
| strength | | | | |
| Recyclability | Solvent used in | Water | Water | Water |
| | alkali solution | | | |
| | Peeling of composite | 1 | 2 | 2 |
| | film | | | |
| | Peeling of adhesive | 1 | 2 | 3 |
| | agent layer | | | |
| Biodegradability | | 1 | 2 | 2 |

As a result, Examples 1 to 6 had not only the required adhesive strength but also very excellent releasability and biodegradability. On the other hand, in Comparative Examples, both the releasability and the biodegradability were poor.

1. An adhesive composition comprising:
an oil and/or fat (A) containing an acid anhydride group; and
a curing agent (H),
wherein the curing agent (H) contains an acid-modified polyol (B) and an amine compound (C).

2. The adhesive composition according to claim 1, wherein the oil and/or fat (A) containing an acid anhydride group is a maleic anhydride-modified vegetable oil (A1).

3. The adhesive composition according to claim 1, wherein the acid-modified polyol (B) is an acid-modified polyester polyol.

4. The adhesive composition according to claim 1, wherein the amine compound (C) contains a tertiary amine-containing polyol.

5. A laminate comprising a first substrate, an adhesive agent layer, and a second substrate stacked in this order,
wherein the adhesive agent layer is the adhesive composition according to claim 1.

6. The laminate according to claim 5, wherein the first substrate or the second substrate includes a primer layer and a printed layer, the primer layer containing a urethane resin including a urethane resin (PA) which is a reaction product of an aromatic polyester polyol (a1) containing an aromatic dicarboxylic acid (a1-1) as a raw material monomer and a polyisocyanate (a2), a concentration of an aromatic ring derived from the raw material monomer of the aromatic dicarboxylic acid (a1-1) in the urethane resin (PA) being 1 mmol/g or more, an ester bond group concentration in the urethane resin (PA) being 1 mmol/g or more, and an acid value of the urethane resin (PA) being from 8 to 45 mgKOH/g.

7. A packaging material comprising the laminate according to claim 5 molded into a bag shape.

8. A packaging material comprising the laminate according to claim 6 molded into a bag shape.
